(19) United States
(12) Patent Application Publication
(10) Pub. No.: US 2007/0053445 A1
(43) Pub. Date: Mar. 8, 2007

(54) System and method for providing video content and concealment dependent error protection and scheduling algorithms

(75) Inventors: Mihaela Van Der Schaar, Sacramento, CA (US); Deepak Turaga, Elmsford, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/573,081

(22) PCT Filed: Sep. 21, 2004
(86) PCT No.: PCT/IB04/51810

§ 371 Date: Jul. 3, 2006

Related U.S. Application Data
(60) Provisional application No. 60/505,222, filed on Sep. 23, 2003.

(51) Int. Cl. H04B 1/66; H04L 1/00

(52) U.S. Cl. 375/240.28; 714/746

(57) ABSTRACT

A system and method is provided for adaptively changing as error protection strategy for a digital video transmission depending upon the characteristics of a transmission channel (120). A video classification processor (210) located in a video encoder (114) analyzes a video sequence and (1) determines priority classes for video data packets based on objective criteria, and (2) determines sequence dependent features of the video sequence, and (3) classifies the video data packets in sub-priorities based on the sequence dependent features of the video sequence. The system can also re-classify video data packet priorities based on objective criteria using either the sequence dependent features of the video sequence or an error concealment algorithm.

The present invention is directed, in general, to digital transmission systems and, more specifically, to a system and method for providing video content and concealment dependent error protection and scheduling algorithms for the transmission of digital video signals.

In digital video communications errors may occur during the transmission of digital video signals. When an error consists of a corrupted or missing portion of a transmission, the error may be corrected by retransmitting the corrupted or missing portion. Well known forward error correction (FEC) techniques may also be provided to minimize the error rate in transmitting digital video signals.

Presently available error protection and video transmission scheduling algorithms are either independent of the video data being transmitted or are based on objective, video sequence independent strategies. Such error protection and video transmission scheduling algorithms are based on priority information that is determined objectively for all video sequences. For example, in non-scalable predictive coding techniques, different priorities can be assigned to I frames, P frames and B frames. Alternatively, different priorities can be assigned to a base partition and to an enhancement partition. In scalable coding techniques, different priorities can be assigned to the base layer and to the enhancement layer.

The priorities that are assigned in this fashion subsequently determine the retransmission limits, the forward error correction (FEC) protection, and scheduling algorithms. The disadvantage of the prior art scheduling algorithms is that they do not consider the video sequence characteristics and the sensitivity of the video sequence to losses. Therefore, the prior art scheduling algorithms are not able to control the visual quality of the video sequence in the presence of losses in error-prone networks such as the Internet and wireless networks.

There is therefore a need in the art for a system and method that is capable of adaptively changing an error protection strategy for a video transmission depending upon the characteristics of the transmission channel. There is also a need in the art for a system and method that is capable of providing error protection and scheduling algorithms for improving the performance of video transmission over error-prone channels.

To address the deficiencies of the prior art mentioned above, the system and method of the present invention classifies the various priority classes of video data packets based upon the video sequence characteristics and sensitivity to loss. The system and method of the present invention also classifies the various priority classes of video data packets based upon the error concealment strategy that is being employed.

The system and method of the present invention comprises a video classification processor that is located within a video encoder of a video transmitter. The video classification processor is capable of receiving and analyzing a video sequence. The video classification processor determines priority classes for video data packets based on objective criteria. The video classification processor also determines the sequence dependent features of the video sequence. The video classification processor then uses the sequence dependent features of the video sequence to classify the video data packets into various sub-priorities.

In another advantageous embodiment of the system and method of the invention, the video classification processor determines an error concealment algorithm that is being used by the video transmitter. The video classification processor also determines a mean square error for a lost video data packet and classifies the video data packets in sub-priorities based on the mean square error and the error concealment algorithm.

In yet another advantageous embodiment of the system of the invention, the video classification processor is capable of re-classifying the priorities of the video data packets that have been determined according to objective criteria. The video classification processor accomplishes this by using the sequence dependent features of the video sequence and/or the error concealment algorithm.

It is an object of the present invention to provide a system and method for classifying video data packets of a video sequence into sub-classes so that the video data packets can be differentially scheduled.

It is another object of the present invention to provide a system and method for classifying video data packets of a video sequence based upon an error concealment strategy that is employed in a digital video transmitter.

It is also an object of the present invention to provide a system and method for determining a priority of a video data packet based upon a mean square error between an original data packet and a concealed data packet.

It is another object of the present invention to provide a system and method for determining a priority for a lost video data packet based upon an incurred distortion when the video data packet is lost.

It is also an object of the present invention to provide a system and method for modifying priority classifications of video data packets of a video sequence that have been determined according to objective criteria by using sequence dependent features of the video sequence and/or an error concealment algorithm.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior uses, as well as future uses, of such defined words and phrases.

For a more complete understanding of the present invention, and the advantages thereof, reference is now made to the following descriptions taken in conjunction with the accompanying drawings, wherein like numbers designate like objects, and in which:

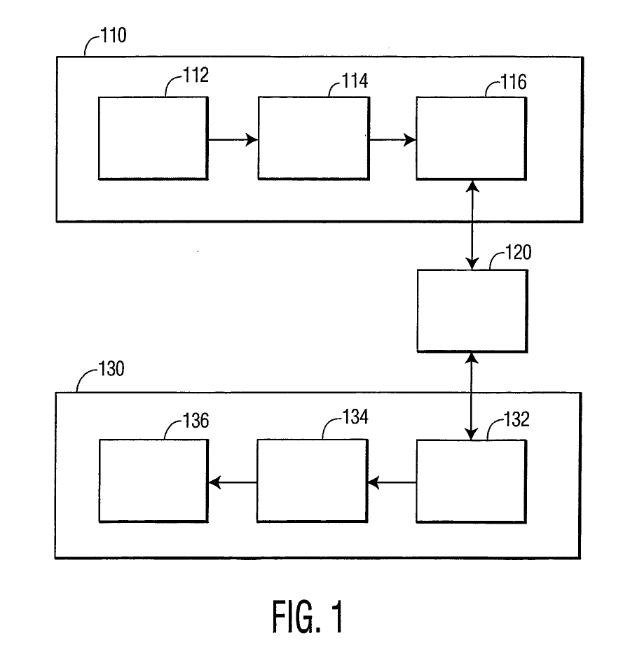

FIG. 1 is a block diagram illustrating an end-to-end transmission of streaming video from a streaming video transmitter through a data network to a streaming video receiver according to an advantageous embodiment of the present invention;

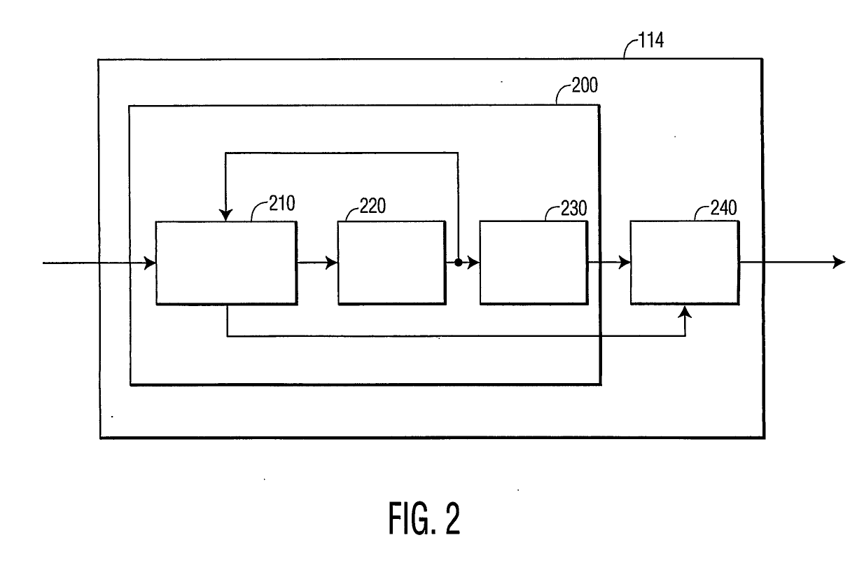

FIG. 2 is a block diagram illustrating an exemplary video encoder according to an advantageous embodiment of the present invention;

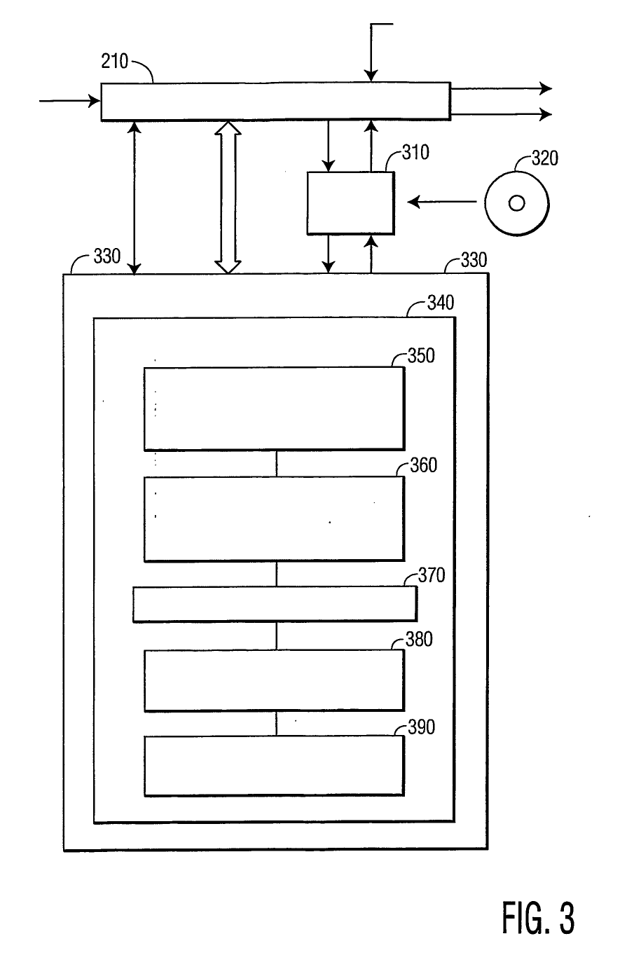

FIG. 3 is a block diagram illustrating an exemplary video classification processor according to an advantageous embodiment of the present invention;

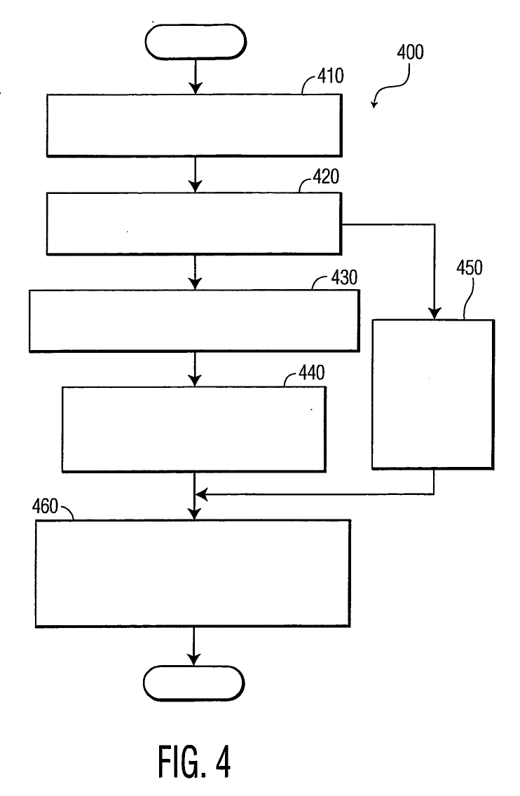

FIG. 4 illustrates a flowchart showing the steps of a first method of an advantageous embodiment of the present invention;

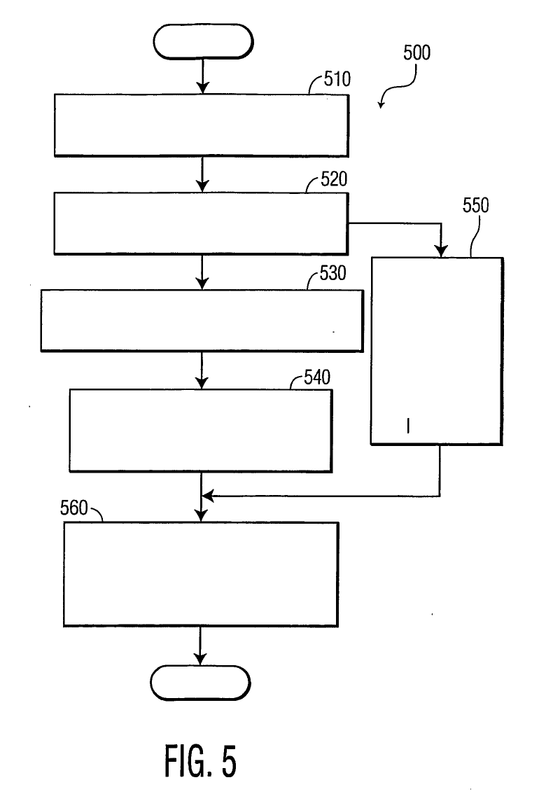

FIG. 5 illustrates a flowchart showing the steps of a second method of an advantageous embodiment of the present invention;

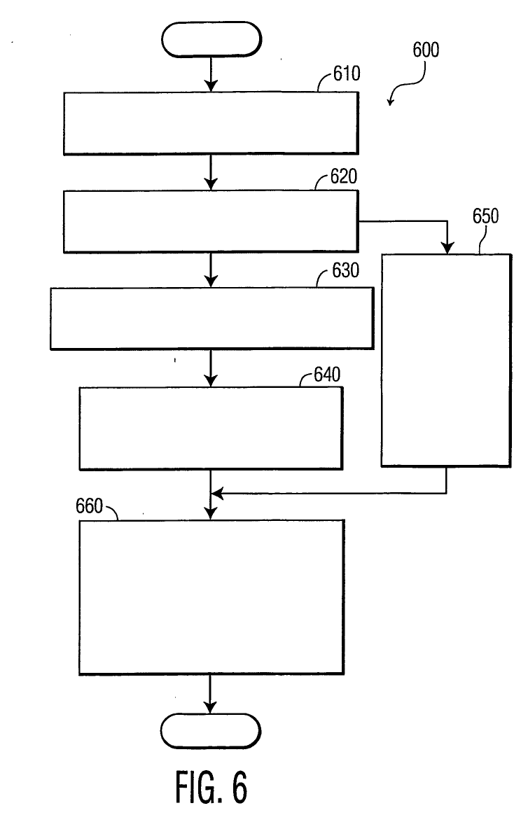

FIG. 6 illustrates a flowchart showing the steps of a third method of an advantageous embodiment of the present invention; and

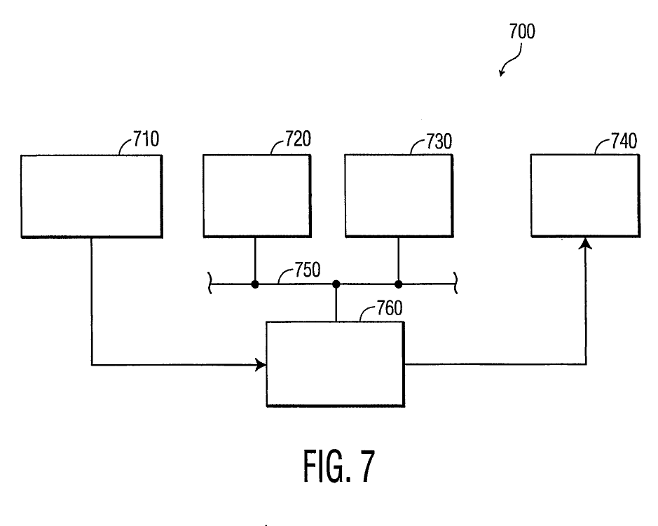

FIG. 7 illustrates an exemplary embodiment of a digital transmission system that may be used to implement the principles of the present invention.

FIGS. 1 through 7, discussed below, and the various embodiments used to describe the principles of the present invention in this patent document are by way of illustration only and should not be construed in any way to limit the scope of the invention. The present invention may be used in any digital video signal transmitter.

FIG. 1 is a block diagram illustrating an end-to-end transmission of streaming video from streaming video transmitter 110, through data network 120 to streaming video receiver 130, according to an advantageous embodiment of the present invention. Depending on the application, streaming video transmitter 110 may be any one of a wide variety of sources of video frames, including a data network server, a television station, a cable network, a desktop personal computer (PC), or the like.

Streaming video transmitter 110 comprises video frame source 112, video encoder 114 and encoder buffer 116. Video frame source 112 may be any device capable of generating a sequence of uncompressed video frames, including a television antenna and receiver unit, a video cassette player, a video camera, a disk storage device capable of storing a “raw” video clip, and the like. The uncompressed video frames enter video encoder 114 at a given picture rate (or “streaming rate”) and are compressed according to any known compression algorithm or device, such as an MPEG-4 encoder. Video encoder 114 then transmits the compressed video frames to encoder buffer 116 for buffering in preparation for transmission across data network 120. Data network 120 may be any suitable IP network and may include portions of both public data networks, such as the Internet, and private data networks, such as an enterprise owned local area network (LAN) or wide area network (WAN).

Streaming video receiver 130 comprises decoder buffer 132, video decoder 134 and video display 136. Decoder buffer 132 receives and stores streaming compressed video frames from data network 120. Decoder buffer 132 then transmits the compressed video frames to video decoder 134 as required. Video decoder 134 decompresses the video frames at the same rate (ideally) at which the video frames were compressed by video encoder 114. Video decoder 134 sends the decompressed frames to video display 136 for play-back on the screen of video display 136.

FIG. 2 is a block diagram illustrating exemplary video encoder 114 according to an advantageous embodiment of the present invention. Exemplary video encoder 114 comprises source coder 200 and transport coder 240. Source coder 200 comprises video classification processor 210, waveform coder 220 and entropy coder 230. Video signals are provided from video frame source 112 (shown in FIG. 1) to source coder 200 of video encoder 114. The video signals first enter video classification processor 210 where they are processed in a manner that will be more fully described.

The video signals from video classification processor 210 are sent to waveform coder 220. Waveform coder 220 is a lossy device that reduces the bitrate by representing the original video using transformed variables and applying quantization. Waveform coder 220 may perform transform coding using a discrete cosine transform (DCT) or a wavelet transform. The encoded video signals from waveform coder 220 are sent to entropy coder 230. The encoded video signals from waveform coder 220 are also sent back to video classification processor 210 to provide video classification processor 210 with a copy of the encoded video signals.

Entropy coder 230 is a lossless device that maps the output symbols from waveform coder 220 into binary code words according to a statistical distribution of the symbols to be coded. Examples of entropy coding methods include Huffman coding, arithmetic coding, and a hybrid coding method that uses DCT and motion compensated prediction. The encoded video signals from entropy coder 230 are sent to transport coder 240.

Transport coder 240 represents a group of devices that perform channel coding, packetization and/or modulation, and transport level control using a particular transport protocol. Transport coder 240 coverts the bit stream from source coder 200 into data units that are suitable for transmission. Transport coder 240 also receives control signals from video classification processor 210 to provide instructions to transport coder 240 concerning scheduling and prioritization information for the video data packets. The video signals that are output from transport coder 240 are sent to encoder buffer 116 for ultimate transmission through data network 120 to video receiver 130.

Video classification processor 210 in FIG. 2 is located immediately before waveform coder 220. It is understood that this is only one example of a possible location for video classification processor 210 in source coder 200. In an alternate embodiment of the invention, video classification processor 210 may be located within and made an integral part of waveform coder 220. Video classification processor 210 is shown in FIG. 2 as a separate entity for clarity of explanation.

FIG. 3 is a block diagram illustrating exemplary video classification processor 210 within exemplary video encoder 114 according to an advantageous embodiment of the present invention.

Video classification processor 210 receives video signals and classifies the video signals depending upon the video sequence characteristics and depending upon the error concealment strategy that is being employed.

Video classification processor 210 stores video data packets in memory unit 310. Memory unit 310 may comprise random access memory (RAM). Memory unit 310 may comprise a non-volatile random access memory (RAM), such as flash memory. Memory unit 310 may comprise a mass storage data device, such as a hard disk drive (not shown). Memory unit 310 may also comprise an attached peripheral drive or removable disk drive (whether embedded or attached) that reads read/write DVDs or re-writable CD-ROMs. As illustrated in FIG. 3, removable disk drives of this type are capable of receiving and reading re-writable CD-ROM disk 320.

Video classification processor 210 provides the video data packets to controller 330. Controller 330 is capable of receiving control signals from video classification processor 210 and sending control signals to video classification processor 210. Controller 330 is also coupled to video classification processor 210 through memory unit 310. As will be more fully described, controller 330 is capable of analyzing the characteristics of the video sequences that are received from video classification processor 210.

As shown in FIG. 3, controller 330 comprises video sequence analysis software 340. Video sequence analysis software 340 comprises computer software that is capable of carrying out the process of analyzing video sequences in accordance with the principles of the present invention. In particular, video sequence analysis software 340 comprises the following modules: (1) module 350 for the determination of priority classification based on objective criteria, and (2) module 360 for the determination of sequence dependent features of a video sequence, and (3) video data packet classification module 370, and (4) module 380 for the determination of a concealment algorithm, and (5) module 390 for the determination of the mean squared error (MSE) for a lost video data packet.

Controller 330 and video sequence analysis software 340 together comprise a video sequence analysis controller that is capable of carrying out the system and method of the present invention. Video classification processor 210 comprises the video sequence analysis controller of controller 330 and video sequence analysis software 340. As also shown in FIG. 3, video classification processor 210 has an input from waveform coder 220 (WC 220), an output to waveform coder 220 (WC 220), and an output to transport coder 240 (TC 240).

Video classification processor 210 classifies the video data packets in a video sequence based on the video sequence characteristics and sensitivity to loss. Based upon the classification system of the present invention, the video data packets in the various sub-classes can be protected and scheduled differentially. For example, if a non-scalable coded sequence of IPB frames exhibits a limited amount of motion, then the different sub-priorities can further classify the objectively determined priorities by assigning lower priorities to the various B frames and P frames.

If a data-partitioned coded sequence exhibits a low-frequency texture, then the different sub-priorities can further classify the different objectively determined priorities by assigning lower priorities to the various partitions.

Video classification processor 210 also classifies the video data packets in a video sequence based on the error concealment strategy that is being employed. If the error concealment strategy is known, then the error concealment strategy can be used to determine the priority of the various video data packets. For example, the priority may be based upon the resulting mean square error (MSE) between the original video data packet and the concealed video data packet.

FIG. 4 illustrates a flowchart showing the steps of a first method of an advantageous embodiment of the present invention. The steps are collectively referred to with reference numeral 400.

Video classification processor 210 receives a video sequence (step 410). Then video classification processor 210 analyzes the video sequence (step 420). Controller 330 receives the video data and determines the various priority classes for the video data based upon objective criteria (step 430). Controller 330 then classifies the video data packets according to the objective criteria priorities (step 440).

Controller 330 also determines the sequence dependent features of the video sequence (step 450). Controller 330 then classifies the video data packets into various sub-priorities using the sequence dependent features of the video sequence (step 460). Video classification processor 210 may then output the priority classifications and the sub priority classifications to transport coder 240 for scheduling the transmission of the video data packets.

FIG. 5 illustrates a flowchart showing the steps of a second method of an advantageous embodiment of the present invention. The steps are collectively referred to with reference numeral 500.

Video classification processor 210 receives a video sequence (step 510). Then video classification processor 210 analyzes the video sequence (step 520). Controller 330 receives the video data and determines the various priority classes for the video data based upon objective criteria (step 530). Controller 330 then classifies the video data packets according to the objective criteria priorities (step 540).

Controller 330 also determines the mean squared error (MSE) for a lost packet when a particular error concealment algorithm is being used (step 550). Controller 330 then classifies the video data packets into various sub-priorities using the MSE information for the lost data packet and using the features of the error concealment algorithm (step 560). Video classification processor 210 may then output the priority classifications and the sub-priority classifications to transport coder 240 for scheduling the transmission of the video data packets.

The video data packet priority for a lost video data packet is chosen based upon the incurred distortion when the video data packet is lost. The incurred distortion may be a function of the video bit rate, the delay, the loss rate, the priority based on objective criteria, the error concealment strategy, and visual conflict masking.

In an alternate advantageous embodiment of the present invention, video classification processor 210 is capable of modifying (i.e., overruling) the priority classifications that are based on objective criteria. For example, the enhancement layer for some frames may be more important than the base layer of other frames (e.g., whenever the error concealment mechanism performs very well or when the content does not change, the enhancement layer information can contribute more to the overall picture quality). The enhancement layer data can contain spatio-temporal-SNR improvements on top of the base layer.

FIG. 6 illustrates a flowchart showing the steps of a third method of an advantageous embodiment of the present invention. The steps are collectively referred to with reference numeral 600.

Video classification processor 210 receives a video sequence (step 610). Then video classification processor 210 analyzes the video sequence (step 620). Controller 330 receives the video data and determines the various priority classes for the video data based upon objective criteria (step 630). Controller 330 then classifies the video data packets according to the objective criteria priorities (step 640).

Controller 330 also determines the sequence dependent features of the video sequence and the error concealment algorithm (step 650). Controller 330 then re-classifies (i.e., modifies) the priorities of the video data packets based upon the sequence dependent features of the video sequence and/or based upon the error concealment algorithm that is being used (step 660). Video classification processor 210 may then output the re-classified priority classifications to transport coder 240 for scheduling the transmission of the video data packets.

FIG. 7 illustrates an exemplary embodiment of a system 700 which may be used for implementing the principles of the present invention. System 700 may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. System 700 includes one or more video/image sources 710, one or more input/output devices 760, a processor 720 and a memory 730. The video/image source(s) 710 may represent, e.g., a television receiver, a VCR or other video/image storage device. The video/image source(s) 710 may alternatively represent one or more network connections for receiving video from a server or servers over, e.g., a global computer communications network such as the Internet, a wide area network, a terrestrial broadcast system, a cable network, a satellite network, a wireless network, or a telephone network, as well as portions or combinations of these and other types of networks.

The input/output devices 760, processor 720 and memory 730 may communicate over a communication medium 750. The communication medium 750 may represent, e.g., a bus, a communication network, one or more internal connections of a circuit, circuit card or other device, as well as portions and combinations of these and other communication media. Input video data from the source(s) 710 is processed in accordance with one or more software programs stored in memory 1030 and executed by processor 720 in order to generate output video/images supplied to a display device 740.

In a preferred embodiment, the coding and decoding employing the principles of the present invention may be implemented by computer readable code executed by the system. The code may be stored in the memory 730 or read/downloaded from a memory medium such as a CD-ROM or floppy disk. In other embodiments, hardware circuitry may be used in place of, or in combination with, software instructions to implement the invention. For example, the elements illustrated herein may also be implemented as discrete hardware elements.

While the present invention has been described in detail with respect to certain embodiments thereof, those skilled in the art should understand that they can make various changes, substitutions modifications, alterations, and adaptations in the present invention without departing from the concept and scope of the invention in its broadest form.

1. An apparatus (210) in a digital video transmitter (110) for adaptively changing an error protection strategy of a transmission of digital video signals through a transmission channel (120) depending upon characteristics of the transmission channel (120), said apparatus (210) comprising a video classification processor (210) that is capable of classifying digital video signals based upon sequence dependent characteristics of the digital video signals.

2. An apparatus (210) as claimed in claim 1 wherein said video classification processor (210) is capable of classifying digital video signals based upon an error concealment strategy that is employed in the digital video transmitter (110).

3. An apparatus 210 as claimed in claim 2 wherein said video classification processor (210) determines a priority of at least one video data packet using said error concealment strategy.

4. An apparatus (210) as claimed in claim 3 wherein said video classification processor (210) determines a priority of at least one video data packet based upon a mean squared error between an original data packet and a concealed data packet.

5. An apparatus (210) as claimed in claim 3 wherein said video classification processor (210) determines a priority of at least one video data packet based upon an incurred distortion when a video data packet is lost.

6. An apparatus (210) as claimed in claim 5 wherein said incurred distortion is a function of one of: a video bit rate, a delay, a loss rate, a priority based on objective criteria, an error concealment strategy, and visual conflict masking.

7. An apparatus (210) as claimed in claim 1 wherein said video classification processor (210) classifies priorities of video data packets using objective criteria; and
wherein said video classification processor (210) determines priorities of sub-classes of video data packets differentially.

8. An apparatus (210) as claimed in claim 7 wherein said video classification processor (210) classifies a priority of a sub-class of video data packets by assigning a lower priority to B frames and P frames than to I frames of a video sequence.

9. An apparatus (210) as claimed in claim 7 wherein said video classification processor (210) classifies a priority of a sub-class of video data packets by assigning a lower priority to at least one data partition of a data-partitioned coded video sequence.

10. An apparatus (210) as claimed in claim 1 wherein said video classification processor (210) classifies priorities of video data packets using objective criteria;
wherein said video classification processor (210) determines one of: sequence dependent characteristics of said digital video signals and an error concealment algorithm; and
wherein said video classification processor (210) re-classifies said priorities of said video data packets determined using said objective criteria using one of: said sequence dependent characteristics of said digital video signals and said error concealment algorithm.

11. An apparatus (210) as claimed in claim 1 wherein at least one input of said video classification processor (210) is coupled to an output of a waveform coder (220), and wherein at least one output of said video classification processor (210) is coupled to an input of a transport coder (240).

12. An apparatus (210) as claimed in claim 1 wherein said video classification processor (210) comprises a video sequence analysis controller (330, 340) that comprises: a controller (330) that is capable of executing computer instructions; and
video sequence analysis software (340) that comprises:
a module (350) for determination of priority classification of video data packets based on objective criteria;
a module (360) for determination of sequence dependent features of a video sequence;
a video data packet classification module (370);
a module (380) for determination of an error concealment algorithm; and
a module (390) for determination of mean squared error for a lost video data packet.

13. A method for adaptively changing an error protection strategy of a transmission of digital video signals from a digital video transmitter (110) through a transmission channel (120) depending upon characteristics of the transmission channel (120), said method comprising the steps of:
classifying digital video signals according to objective criteria;
determining sequence dependent characteristics of the digital video signals; and
classifying video data packets in sub-priorities based upon the sequence dependent characteristics of the digital video signals.

14. A method as claimed in claim 13 further comprising the steps of:
determining an error concealment algorithm that is employed in the digital video transmitter; and
classifying video data packets in sub-priorities based upon the error concealment algorithm.

15. A method as claimed in claim 14 further comprising the steps of:
determining a mean squared error for a lost video data packet when said error concealment algorithm is being used; and
classifying video data packets in sub-priorities based upon the mean squared error and the error concealment algorithm.

16. A method as claimed in claim 14 further comprising the step of one of:
re-classifying said priorities of said video data packets determined using said objective criteria by using said sequence dependent characteristics of said digital video signals; and
re-classifying said priorities of said video data packets determined using said objective criteria by using said error concealment algorithm.

17. For use in a digital video signal transmitter (110), computer-executable instructions stored on a computer-readable storage medium (320) for adaptively changing an error protection strategy of a transmission of digital video signals through a transmission channel (120) depending upon characteristics of the transmission channel (120), said computer-executable instructions comprising the steps of:
classifying digital video signals according to objective criteria;
determining sequence dependent characteristics of the digital video signals; and
classifying video data packets in sub-priorities based upon the sequence dependent characteristics of the digital video signals.

18. The computer-executable instructions stored on a computer-readable storage medium (320) as claimed in claim 17 further comprising the steps of:
determining an error concealment algorithm that is employed in the digital video transmitter; and
classifying video data packets in sub-priorities based upon the error concealment algorithm.

19. The computer-executable instructions stored on a computer-readable storage medium (320) as claimed in claim 18 further comprising the steps of:
determining a mean squared error for a lost video data packet when said error concealment algorithm is being used; and
classifying video data packets in sub-priorities based upon the mean squared error and the error concealment algorithm.

20. The computer-executable instructions stored on a computer-readable storage medium (320) as claimed in claim 18 further comprising the step of one of:
re-classifying said priorities of said video data packets determined using said objective criteria by using said sequence dependent characteristics of said digital video signals; and
re-classifying said priorities of said video data packets determined using said objective criteria by using said error concealment algorithm.
